(19) United States
(12) Patent Application Publication
(10) Pub. No.: US 2008/0134078 A1
(43) Pub. Date: Jun. 5, 2008

(54) SCROLLING METHOD AND APPARATUS

(75) Inventor: Sang-jun Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/743,869

(22) Filed: May 3, 2007

(30) Foreign Application Priority Data
Dec. 5, 2006 (KR) 10-2006-0122581

(51) Int. Cl. G06F 3/048

(52) U.S. Cl. 715/784

(57) ABSTRACT

Provided are a method and apparatus for performing scrolling. The method includes receiving a first location and a second location, calculating the angle between the first location and the second location by using a predetermined reference point, determining a direction of and/or an extent of scrolling by using the calculated angle, and performing scrolling according to the determined direction and/or the extent of scrolling. Accordingly, it is possible to allow a user to rapidly search for a desired item by performing scrolling more easily and conveniently than when using the existing method of scrolling a list using a scroll bar.

### CROSS-REFERENCE TO RELATED PATENT APPLICATIONS

This application claims priority from Korean Patent Application No. 10-2006-0122581, filed on Dec. 5, 2006, in the Korean Intellectual Property Office, the disclosure of which is incorporated herein in its entirety by reference.

### BACKGROUND OF THE INVENTION

1. Field of the Invention

The present invention relates to a user interface, and more particularly, to a scrolling method and apparatus capable of displaying a large amount of content that cannot be displayed all at the same time within a screen of a computing apparatus.

2. Description of the Related Art

FIG. 1 is a diagram illustrating a conventional scrolling method using a scroll bar. Referring to FIG. 1, in general, an apparatus that provides an interface using a touch screen also uses a scroll bar 101, such as that used in a personal computer (PC), for scrolling. The scroll bar 101 is generally displayed having a small size on a screen, and thus a user may have difficulties handling the scroll bar 101.

Also, in a case where a gesture-based interface is used, a user may also have difficulties in getting accustomed thereto and may make a mistake handling the interface, since predetermined specific gestures or figures must be input.

### SUMMARY OF THE INVENTION

The present invention provides a scrolling method and apparatus for increasing convenience for a user.

According to an aspect of the present invention, there is provided a method of performing scrolling, the method comprising receiving a first location and a second location; determining an angle between the first location and the second location by using a predetermined reference point; determining at least one of a direction of and an extent of scrolling by using the determined angle; and performing scrolling according to the at least one of determined direction and extent of scrolling.

The receiving of the first location and the second location may comprise detecting a location touched using a touch-based input device and at predetermined intervals of time.

The receiving of the first location and the second location may comprise detecting a location of a cursor at predetermined intervals of time when performing dragging using an input device.

The determining of the direction of scrolling according to the determined angle may comprise determining the direction of scrolling according to a sign of the angle.

The determining of the direction of scrolling according to the determined angle may comprise determining scrolling a total number of items, where the total number is calculated by dividing the angle by a predetermined value.

The receiving of the first location and the second location may comprise, when a gesture of drawing an arch or a circle is input, receiving locations of points, which form the arch or the circle, at predetermined intervals of time.

The method may further comprise determining a central point in the arch or the circle as the predetermined reference point.

The determining of the extent of scrolling may comprise determining the extent of scrolling according to a speed at which a gesture inputting the first location and the second location is input.

The method may further comprise determining a central point on a screen as the predetermined reference point.

According to another aspect of the present invention, there is provided an apparatus for performing scrolling, the apparatus comprising an input unit via which a first location and a second location are input; a gesture analysis unit determining an angle between the first location and the second location by using a predetermined reference point, and determining at least one of a direction of and an extent of scrolling using the determined angle; and a central processing unit performing scrolling according to the determined at least one of direction of and the extent of scrolling.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a diagram illustrating a conventional scrolling method using a scroll bar;

FIG. 2 is a block diagram of a scrolling apparatus according to an exemplary embodiment of the present invention;

FIG. 3 is a flowchart of a scrolling method according to an exemplary embodiment of the present invention;

FIG. 4 is a diagram illustrating a principle of determining a direction and extent of scrolling according to an exemplary embodiment of the present invention;

FIG. 5 is a flowchart of a scrolling method according to another exemplary embodiment of the present invention;

FIGS. 6A through 6C are diagrams illustrating a scrolling operation according to an exemplary embodiment of the present invention; and

FIG. 7 is a diagram illustrating inputting of a gesture according to an exemplary embodiment of the present invention.

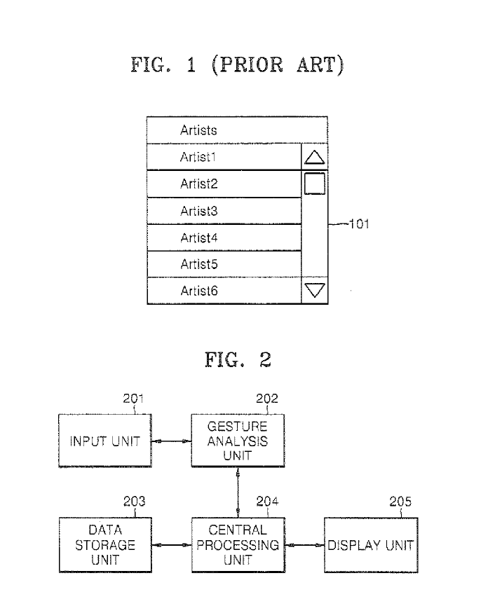

### DETAILED DESCRIPTION OF THE EXEMPLARY EMBODIMENTS OF THE INVENTION

Hereinafter, exemplary embodiments of the present invention will be described in detail with reference to the accompanying drawings.

FIG. 2 is a block diagram of a scrolling apparatus according to an exemplary embodiment of the present invention. Referring to FIG. 2, the scrolling apparatus includes an input unit 201, a gesture analysis unit 202, a data storage unit 203, a central processing unit 204, and a display unit 205. The input unit 201 is used to receive an input from a user. The input unit 201 may be a touch-based input device, such as a touch screen or a touch pad, but it is not limited thereto. That is, the input unit 201 may be any type of an input device that allows a user to input a first location and a second location by dragging or pointing on a screen. The gesture analysis unit 202 analyzes a gesture of the user received via the input unit 201, and determines a direction of and/or an extent of scrolling. The central processing unit 204 reads from the data storage unit 203 a list or content that is to be displayed on the screen, displays the read list or content on the display unit 205, performs scrolling according to the direction of and/or the extent of scrolling determined by the gesture analysis unit 202, and outputs a screen image changed according to the result of scrolling to the display unit 205.

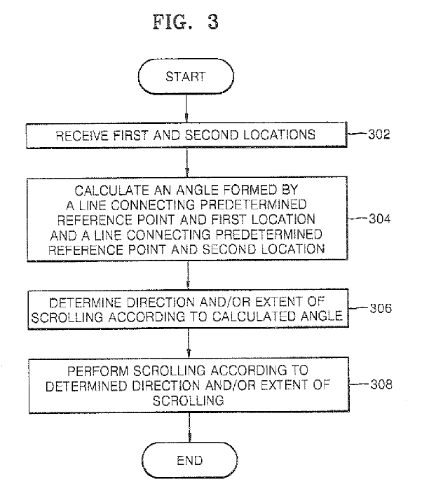

FIG. 3 is a flowchart illustrating a scrolling method according to an exemplary embodiment of the present invention. Referring to FIGS. 2 and 3, the input unit 201 receives from a user information regarding a plurality of locations for determining a direction of and an extent of scrolling (operation 302). The user may input a gesture for scrolling by dragging with his/her finger or a stylus on a touch-based input device. For example, the user inputs a circle, an arc, or the like. The user may input a gesture by moving a cursor with a pointing device, such as a mouse. For example, the user may drag a mouse according to a desired extent of scrolling and in a desired direction. In this case, if it is possible to recognize a change in an angle with respect to a reference point, there is no need to input a gesture for drawing a particular shape. A conventional method, in which a scroll bar is used for scrolling, is disadvantageous in that a button must be pressed several times or a scroll bar must be clicked several times. However, according to an exemplary embodiment of the present invention, scrolling can be performed in continuous patterns rather than in discontinuous patterns. The input unit 201 periodically detects and outputs a location touched by the user or a location of a cursor, i.e., at predetermined intervals of time.

The gesture analysis unit 202 receives the information regarding the locations from the input unit 201, and calculates a change angle with respect to a predetermined reference point. The information regarding the locations may be coordinates of each of the locations. The gesture analysis unit 202 calculates an angle formed by a line that connects a first location and a predetermined reference point and a line that connects a second location and the predetermined reference point, where the first and second locations are continuously detected, in order to calculate the change angle (operation 304). The gesture analysis unit 202 determines a direction of and/or an extent of scrolling by using the calculated angle. The central processing unit 204 performs scrolling in the determined direction of scrolling and by the determined extent of scrolling (operation 308). As a result, an image changed by scrolling is displayed on the screen.

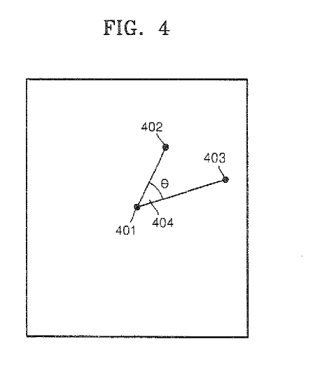

FIG. 4 is a diagram explaining the principle of determining a direction of and the extent of scrolling according to an exemplary embodiment of the present invention. Referring to FIG. 4, a user changes a location that is touched from a first location 402 to a second location 403 on a touch screen for a certain period of time. The change angle θ 404 formed by a line connecting the first location 402 and the reference point 401 and a line connecting the second location 403 and the reference point 401, is used to determine the direction and extent of scrolling. If a list is to be scrolled, the total number of items that are to be scrolled is determined by the change angle θ. If a content display or an image that is to be reproduced is to be scrolled, a scrolling distance is determined by the change angle θ. The gesture analysis unit 202 may determine an extent of scrolling according to a speed at which the user inputs a gesture. That is, when the user inputs a gesture at a high speed, the change angle θ is large, and thus, the extent of scrolling is determined to be large. When the user inputs a gesture at a low speed, the change angle θ is small, and thus, the extent of scrolling is determined to be small.

Also, a direction of scrolling is determined by the sign of the change angle θ. For example, scrolling may be performed upward when the change angle θ is a negative value and performed downward when the change angle θ is a positive value, and one item may be scrolled whenever the change angle θ is changed by 10°. Referring to FIG. 4, when the change angle θ is calculated to be +43°, four items are scrolled downward. However, the method of determining a direction of scrolling according to an exemplary embodiment the present invention is not limited to the above description. For example, if a gesture is input at the left side of a reference point, scrolling may be determined to be performed upward when the change angle θ is a positive value, and to be performed downward when the change angle θ is a negative value. Also, according to another exemplary embodiment of the present invention, scrolling can be performed horizontally to the left of or to the right according to the sign of the change angle θ.

The reference point 401 may be set to be a central point on a screen or in a window that is to be scrolled as described above, but it is not limited thereto and can be variously set. For example, when a user input is in the form of a gesture on one of the quadrants in an image, a central point in the quadrant may be set as a reference point when a change angle is calculated. When a user input is performed by drawing a circle or an arch, a central point in the circle or the arch may be a reference point. Also, when the user's gesture is changed, for example, when the user repeatedly draws a circle thus changing the location or the size of the circle, the location of the reference point may be changed accordingly.

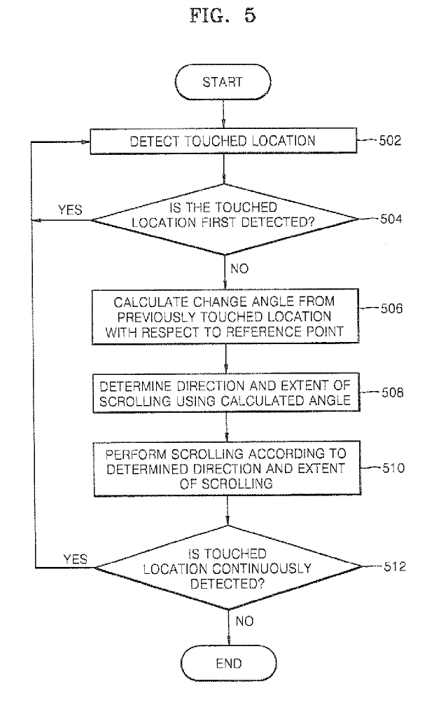

FIG. 5 is a flowchart of a scrolling method when the input unit 201 of FIG. 2 is a touch-based input device, according to another exemplary embodiment of the present invention. Referring to FIGS. 2 and 5, when the input unit 201 detects a location (coordinates) touched by a user and transmits the result of detecting to the gesture analysis unit 202 (operation 502), the gesture analysis unit 202 determines whether the touched location is a touched location that is first detected (operation 504). If the touched location is first detected, another location that is touched by the user awaits to be received, and if not received, the change angle between a previously touched location and the currently touched location is calculated with respect to a reference point (operation 506). Next, if a direction and extent of scrolling are calculated using the calculated change angle and are transmitted to the central processing unit 204 (operation 508), the central processing unit 204 performs scrolling according to the determined direction and extent, and displays the process and result of scrolling to the user (operation 510). If touched locations are continuously detected (operation 512), it means that the user continuously performs dragging without taking away his/her finger or a stylus from a screen or a touch pad, and therefore, the detected, touched locations are continuously transmitted to the gesture analysis unit 202 (operation 502).

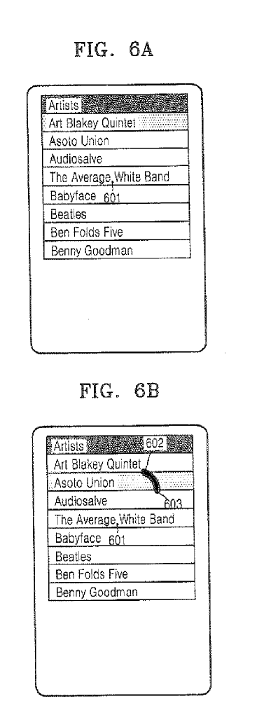

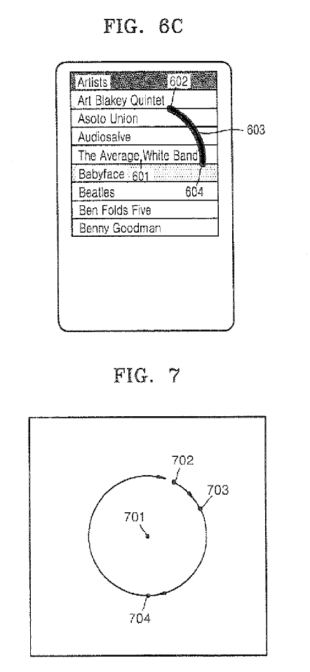

FIGS. 6A through 6C are diagrams illustrating scrolling operations according to an exemplary embodiment of the present invention. In detail, FIGS. 6A through 6C illustrate a case where an exemplary embodiment of the present invention is applied to a search for desired content from a mobile device.

FIG. 6A illustrates an initial state of a list of items that can be scrolled, in which a central point in a screen is set to be a reference point 601. Referring to FIG. 6B, a user starts touching at a first location 602, and performs dragging by about +10° from the reference point 601 to a second location 603. As a result, scrolling is performed in a downward direction by one item, thereby highlighting a second item. Referring to FIG. 6C, the user drags a finger or stylus through the second location 603 to a third location 604 and thus, a fifth item is scrolled to.

FIGS. 6A through 6C illustrate a case where an exemplary embodiment of the present invention is applied to a small-sized mobile device, but the present invention is not limited thereto. The present invention can be applied to various computing devices.

FIG. 7 is a diagram illustrating inputting of a gesture according to an exemplary embodiment of the present invention. In detail, FIG. 7 illustrates a case where a user inputs a gesture by drawing an arch or a circle in order to perform a scrolling operation.

If the gesture is input by drawing an arch or a circle, the input unit 201 detects the locations of points forming the arch or the circle repeatedly, e.g., at predetermined intervals of time, and transmits them to the gesture analysis unit 202. In this case, the gesture analysis unit 202 may determine a central point 701 in the arch or the circle as a reference point. If the user draws the circle rapidly, scrolling may be performed rapidly, and if the user draws the circle slowly, scrolling may be performed slowly. Referring to FIG. 7, the user inputs a gesture by drawing a circle clockwise, starting from a first location 702. Then, the first location 702, a second location 703, and a third location 704 are continuously detected at predetermined intervals of time, and a scrolling speed is higher when dragging is performed from the second location 703 to the third location 704 than when dragging is performed from the first location 702 to the second location 703. Accordingly, the user is able to scroll an image or a list on a screen without stopping the input of gestures while adjusting a scrolling speed to a desired level. The user can continuously perform scrolling by repeatedly drawing the circle without taking away his/her hand from the screen or the like.

The above method according to the present invention can be embodied as computer readable code in a computer readable medium.

As described above, according to the present invention, a user can rapidly detect a desired item by scrolling more easily and conveniently than when using a conventional method of scrolling a list using a scroll bar.

Also, according to the present invention, a user can easily perform scrolling on a touch screen or a touch pad built into a mobile media player into which a gesture can be input, using his/her finger or a stylus. Also, since a gesture can be input without drawing a particular figure, the user can become easily accustomed to using the mobile media player.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A method of performing scrolling, comprising:
receiving a first location and a second location;
determining an angle between the first location and the second location by using a predetermined reference point;
determining at least one of a direction of and an extent of scrolling by using the determined angle; and
performing scrolling according to the at least one of the determined direction and the extent of scrolling.

2. The method of claim 1, wherein the receiving of the first location and the second location comprises detecting the first location touched using a touch-based input device and at predetermined intervals of time.

3. The method of claim 1, wherein the receiving of the first location and the second location comprises, when performing dragging using an input device, detecting a cursor location at predetermined intervals of time.

4. The method of claim 1, wherein the determining of the direction of scrolling according to the determined angle comprises determining the direction of scrolling according to a sign of the angle.

5. The method of claim 1, wherein the determining of the at least one direction of scrolling according to the determined angle comprises determining scrolling a total number of items, where the total number of items is calculated by dividing the angle by a predetermined value.

6. The method of claim 1, wherein the receiving of the first location and the second location comprises, when a gesture of drawing an arch or a circle is input, receiving point locations, which form the arch or the circle, at predetermined intervals of time.

7. The method of claim 6, further comprising determining a central point in the arch or the circle as the predetermined reference point.

8. The method of claim 1, wherein the determining of the extent of scrolling comprises determining the extent of scrolling according to a speed at which a gesture inputting the first location and the second location is input.

9. The method of claim 1, further comprising determining a central point on a screen as the predetermined reference point.

10. An apparatus for performing scrolling, comprising:
an input unit via which a first location and a second location are input;
a gesture analysis unit determining an angle between the first location and the second location by using a predetermined reference point, and determining at least one of a direction of scrolling and an extent of scrolling using the determined angle; and
a central processing unit performing scrolling according to the determined at least one of direction of scrolling and the extent of scrolling.

11. The apparatus of claim 10, wherein the input unit is a touch-based input device,
wherein the touch-based input device detects touched locations at predetermined intervals of time, and determines the touched locations as the first location and the second location.

12. The apparatus of claim 10, wherein the input unit detects cursor locations at predetermined intervals of time when dragging is performed, and determines the cursor locations as the first location and the second location.

13. The apparatus of claim 10, wherein the gesture analysis unit determines the direction of scrolling according to a sign of the angle.

14. The apparatus of claim 10, wherein the gesture analysis unit determines scrolling a total number of items, where the total number is calculated by dividing the angle by a predetermined value.

15. The apparatus of claim 10, wherein, when a gesture of drawing an arch or a circle is input, the input unit detects locations of points, which form the arch or the circle, at predetermined intervals of time.

16. The apparatus of claim 15, wherein the gesture analysis unit determines a central point in the arch or the circle as the predetermined reference point.

17. The apparatus of claim 10, wherein the gesture analysis unit determines the extent of scrolling according to a speed at which a gesture inputting the first location and the second location is input.

18. The apparatus of claim 10, wherein the gesture analysis unit determines a central point on a screen as the predetermined reference point.

19. A computer readable medium having recorded thereon instructions for causing a computer to execute a method, the method comprising:
receiving a first location and a second location;
determining an angle between the first location and the second location by using a predetermined reference point;
determining at least one of a direction of and an extent of scrolling by using the determined angle; and performing scrolling according to the at least one of the determined direction and the extent of scrolling.
